(19) United States
(12) Patent Application Publication
(10) Pub. No.: US 2006/0221016 A1
(43) Pub. Date: Oct. 5, 2006

(54) DISPLAY

(76) Inventor: Norio NAKAMURA, Kanazawa-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/277,000

(22) Filed: Mar. 20, 2006

(30) Foreign Application Priority Data
Mar. 30, 2005 (JP) 2005-098657

(51) Int. Cl. G09G 3/32

(52) U.S. Cl. 345/82

(57) ABSTRACT

A display includes a video signal line, a current source which outputs a video signal, a voltage source which outputs a reset signal, and pixels each of which includes a drive circuit and a display element. The display executes a reset operation during a blanking period. The reset operation includes connecting the voltage source to the video signal line to write the reset signal on the video signal line while disconnecting the current source from the video signal line.

### CROSS-REFERENCE TO RELATED APPLICATIONS

This application is based upon and claims the benefit of priority from prior Japanese Patent Application No. 2005-098657, filed Mar. 30, 2005, the entire contents of which are incorporated herein by reference.

### BACKGROUND OF THE INVENTION

1. Field of the Invention

The present invention relates to a display, and in particular, to an active matrix display in which pixels are supplied with current signals as video signals.

2. Description of the Related Art

U.S. Pat. No. 6,373,454 describes an active matrix organic electroluminescent (EL) display in which each pixel circuit includes a current mirror circuit. In this display, a current signal is supplied to each pixel as a video signal to allow an organic EL element to emit light at a luminance corresponding to the magnitude of the video signal.

To drive the display, an active scanning period and a blanking period (vertical blanking period) are normally alternated. During the active scanning period, for example, pixels are sequentially selected for each row, and a video signal is written to the selected pixels. The organic EL element in each pixel should emit light at the luminance corresponding to the magnitude of the video signal, during a non-selection period of the active scanning period and during the blanking period.

However, the present inventor has found the following fact in making the present invention. In a display in which a current signal is written to each pixel as a video signal, pixels in several rows first selected during an active scanning period may not display gray levels in a low gray level range with a high reproducibility. This is particularly marked if video signal lines connect to a protection circuit that prevents electrostatic damage to a circuit in a video signal line driver or in each pixel.

### BRIEF SUMMARY OF THE INVENTION

An object of the present invention is to make it possible that a display in which a current signal is written to each pixel as a video signal achieves an excellent image quality on pixels in rows first selected during an active scanning period.

According to an aspect of the present invention, there is provided a display comprising a video signal line, a current source which outputs a video signal, a voltage source which outputs a reset signal, and pixels which are arranged along the video signal line, each of the pixels including a drive circuit which outputs a drive current at a magnitude corresponding to a magnitude of a video signal, and a display element which changes its optical characteristics in accordance with a magnitude of a current flow through the display element, wherein the display is configured to alternately repeat an active scanning period and a blanking period, sequentially select the pixels during the active scanning period, execute a write operation on the selected pixel, execute a display operation on each of the non-selected pixels, and execute a reset operation during the blanking period, wherein the write operation includes connecting the drive circuit to the current source via the video signal line to write the video signal on the drive circuit while disconnecting the display element from the drive circuit, wherein the display operation includes connecting the drive circuit to the display element to make the drive current flow through the display element while disconnecting the drive circuit from the video signal line, and wherein the reset operation includes connecting the voltage source to the video signal line to write the reset signal on the video signal line while disconnecting the current source from the video signal line.

### BRIEF DESCRIPTION OF THE SEVERAL VIEWS OF THE DRAWING

FIG. 1 is a plan view schematically showing a display according to a first embodiment of the present invention;

FIG. 2 is a partial sectional view schematically showing an example of a structure that can be adopted for the display shown in FIG. 1;

FIG. 3 is an equivalent circuit diagram showing a part of the display shown in FIG. 1;

FIG. 4 is a timing chart schematically showing an example of a method of driving the display shown in FIGS. 1 to 3; and

FIG. 5 is an equivalent circuit diagram showing a part of a display according to the second embodiment of the present invention.

### DETAILED DESCRIPTION OF THE INVENTION

Embodiments of the present invention will be described below in detail with reference to the drawings. In the drawings, components achieving the same or similar functions are denoted by the same reference numerals and duplicate descriptions will be omitted.

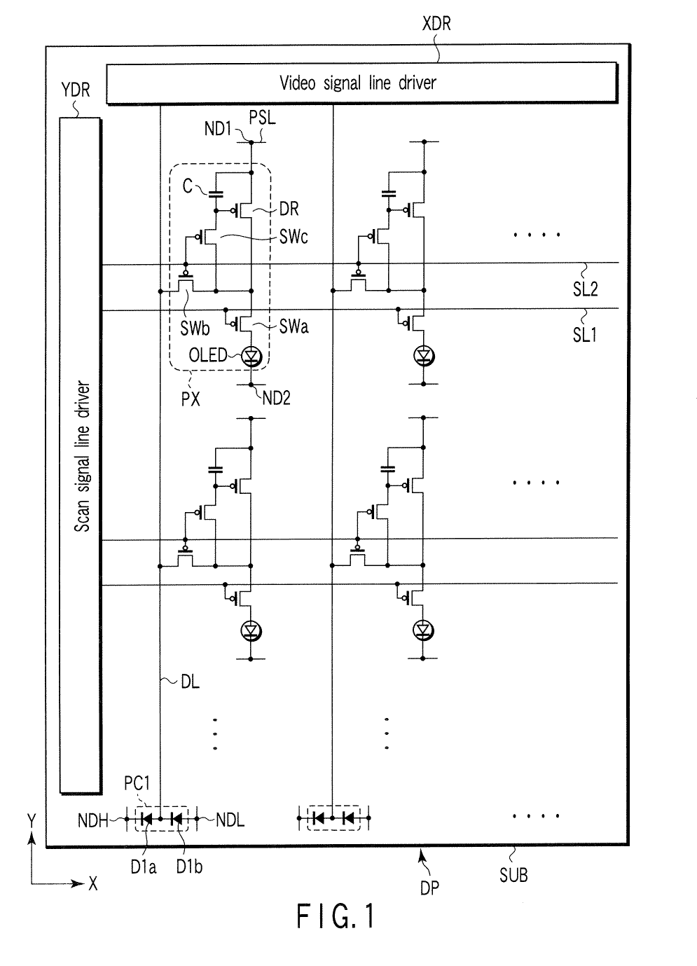

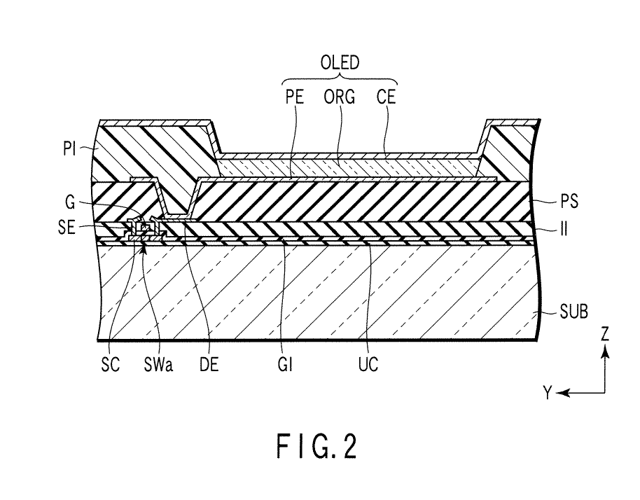

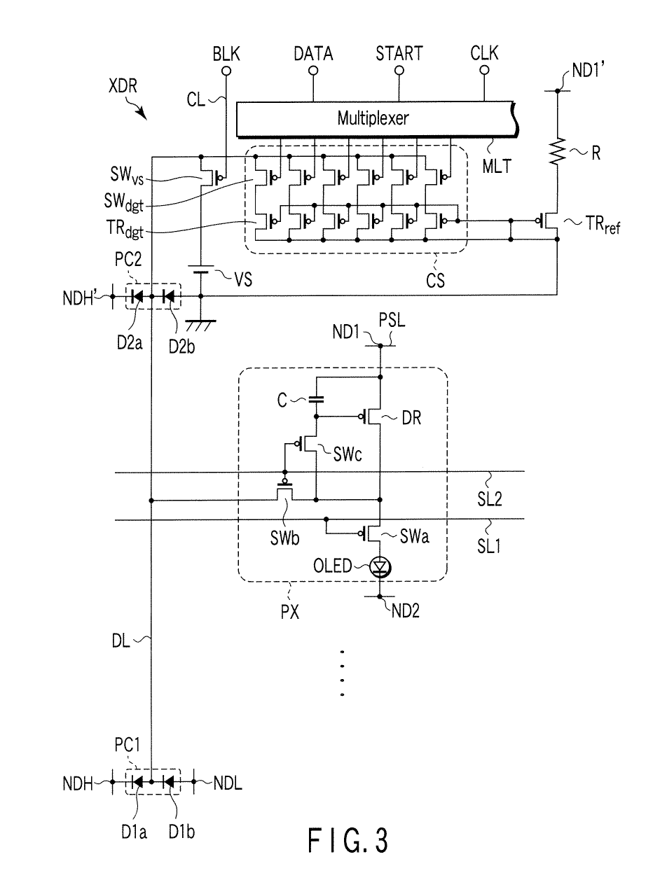

FIG. 1 is a plan view schematically showing a display according to a first embodiment of the present invention. FIG. 2 is a partial sectional view schematically showing an example of a structure that can be adopted for the display shown in FIG. 1. FIG. 3 is an equivalent circuit diagram showing a part of the display shown in FIG. 1. In FIG. 2, the display is drawn so that its display surface, that is, its front surface or light emitting surface faces the bottom of the drawing, while its rear surface faces the top of the drawing.

The display is a bottom emission organic EL display employing an active matrix driving method. The organic EL display includes a display panel DP, a video signal line driver XDR, and a scan signal line driver YDR.

The display panel DP includes an insulating substrate SUB such as a glass substrate. For example, an SiNₓ layer and an SiOₓ layer are sequentially stacked on the substrate SUB as an undercoat layer UC shown in FIG. 2.

Semiconductor layers SC such as polysilicon layers in each of which source and drain are formed, a gate insulator GI which may be formed by using tetraethyl orthosilicate (TEOS), and gates G which are made of, for example, MoW are sequentially stacked on the undercoat layer UC to form top gate-type thin-film transistors. In this embodiment, the thin-film transistors are p-channel thin-film transistors and n-channel thin-film transistors. The p-channel thin-film transistors are utilized as drive control elements DR, switches SWa to SWc, and diodes D1a shown in FIGS. 1 and 3. The n-channel thin-film transistors are utilized as diodes D1b shown in FIGS. 1 and 3.

Bottom electrodes of capacitors C and scan signal lines SL1 and SL2 shown in FIGS. 1 and 3 are further arranged on the gate insulator GI. These components can be formed in the same step as that for the gates G.

As shown in FIG. 1, the scan signal lines SL1 and SL2 extend along the rows of the pixels PX, i.e., in an X direction, and are arranged in a Y direction along the columns of the pixels PX. The scan signal lines SL1 and SL2 are connected to the scan signal line driver YDR.

An interlayer insulating film II shown in FIG. 2 covers the gate insulator GI, the gates G, the scan signal lines SL1 and SL2, and the bottom electrodes of the capacitors C. The interlayer insulating film II is, for example, an SiOₓ layer formed by plasma CVD. Parts of the interlayer insulating film II are utilized as dielectric layers of the capacitors C.

On the interlayer insulating film II, top electrodes of the capacitors C shown in FIGS. 1 and 3, source electrodes SE and drain electrodes DE shown in FIG. 2, and video signal lines DL and power supply lines PSL shown in FIGS. 1 and 3 are arranged. These components can be formed in the same step and may have a three-layer structure of, for example, Mo, Al, and Mo.

The source electrodes SE and drain electrodes DE are electrically connected to sources and drains of the thin-film transistors via contact holes formed in the interlayer insulting film II.

As shown in FIG. 1, the video signal lines DL extend in the Y direction and are arranged in the X direction. The video signal lines DL are connected to the video signal line driver XDR.

The power supply lines PSL extend in the Y direction and are arranged in the X direction, for example.

A passivation film PS shown in FIG. 2 covers the source electrodes SE, drain electrodes DE, video signal lines DL, power supply lines PSL, and top electrodes of the capacitors C. The passivation film PS is made of, for example, SiNₓ.

As shown in FIG. 2, light-transmissive first electrodes PE as front electrodes are arranged on the passivation film PS such that they are spaced apart from one another. Each of the first electrodes PE is a pixel electrode connected through a through-hole formed in the passivation film PS to the drain electrode DE to which the drain of the switch SWa is connected.

In this embodiment, the first electrode PE is an anode. A transparent conductive oxide, for example, indium tin oxide (ITO) can be used as a material of the first electrode PE.

A partition insulating layer PI shown in FIG. 2 is further placed on the passivation film PS. The partition insulating layer PI has through-holes formed at positions corresponding to the first electrodes PE or slits formed at positions corresponding to columns or rows formed by the first electrodes PE. Here, by way of example, the partition insulating layer PI has through-holes formed at positions corresponding to the first electrodes PE.

The partition insulating layer PI is, for example, an organic insulating layer. The partition insulating layer PI can be formed using, for example, a photolithography technique.

An organic layer ORG including an emitting layer is placed on each of the first electrodes PE as an active layer. The emitting layer is, for example, a thin film containing a luminescent organic compound that emits red, green, or blue light. In addition to the emitting layer, the organic layer ORG may include a hole injection layer, a hole transporting layer, a hole blocking layer, an electron transporting layer, and an electron injection layer.

The partition insulating layer PI and the organic layer ORG are covered with a second electrode CE as a counter electrode. The second electrode CE is a common electrode shared among the pixels PX. In this embodiment, the second electrode CE is a light-reflective cathode serving as a back electrode. For example, an electrode wire (not shown) is formed on the layer on which the video signal lines DL are formed, and the second electrode CE is electrically connected to the electrode wire via a contact hole formed in the passivation film PS and partition insulating layer PI. Each organic EL element OLED is composed of the first electrode PE, organic layer ORG, and second electrode CE.

A plurality of the pixels PX are arranged in a matrix on the insulating substrate SUB. Each of the pixels PX is placed near an intersection of the video signal line DL and scan signal line SL1.

Each pixel PX includes the organic EL element OLED as a display element, a drive circuit, and an output control switch SWa. In this embodiment, as shown in FIGS. 1 and 3, the drive circuit includes a drive control element DR, a selector switch SWb, a diode-connecting switch SWc, and the capacitor C. As described above, in this embodiment, the drive control element DR and switches SWa to SWc are p-channel thin-film transistors. The switches SWb and SWc form a switch group which switches between a first state that the drain and gate of the drive control element DR and the video signal line DL are connected to one another and a second state they are disconnected from one another.

The drive control element DR, the output control switch SWa, and the organic EL element OLED are connected in series between a first power supply terminal ND1 and a second power supply terminal ND2 in this order. In this embodiment, the first power supply terminal ND1 is a high-potential power supply terminal connected to a power supply line PSL. The second power supply terminal ND2 is a low-potential power supply terminal.

A gate of the switch SWa is connected to the scan signal line SL1. The selector switch SWb is connected between the video signal line DL and the drain of the drive control element DR. The gate of the selector switch SWb is connected to the scan signal line SL2. The diode-connecting switch SWc is connected between the drain and gate of the drive control element DR. The gate of the diode-connecting switch SWc is connected to the scan signal line SL2.

The capacitor C is connected between a constant-potential terminal and the gate of the drive control element DR. In this embodiment, the capacitor C is connected between the first power supply terminal ND1 and the gate of the drive control element DR.

A protection circuit PC1 is connected to each video signal line DL. The protection circuit PC1 includes diodes D1a and D1b. The diode D1a is connected between the video signal line DL and a high-potential terminal NDH such that a forward current flows through the diode D1a from the video signal line DL to the high-potential terminal NDH. A potential of the high-potential terminal NDH is to be set higher than that of the video signal line DL. The diode D1b is connected between the video signal line DL and a low-potential terminal NDL such that a forward current flows through the diode D1a from the high-potential terminal NDH to the video signal line DL. A potential of the low-potential terminal NDL is to be set lower than that of the video signal line DL. In this embodiment, the diode D1a is a p-channel thin-film transistor whose gate is connected to the high-potential terminal NDH, and the diode D1b is an n-channel thin-film transistor whose gate is connected to the low-potential terminal NDL.

The video signal line driver XDR is mounted on the display panel DP. As shown in FIG. 3, the video signal line driver XDR includes a current source CS, a switch SWvs, and a protection circuit PC2 for each video signal line DL. The video signal line driver XDR further includes multiplexer MLT, a voltage source VS, a reference transistor TR_{ref}, and a control line CL.

The multiplexer MLT includes input terminals to which a clock signal CLK, a start signal START, a video signal DATA as a serial signal are supplied. The multiplexer MLT further includes output terminals for each current source CS. The multiplexer MLT converts the video signal DATA from a serial signal into parallel signals under control of the clock signal CLK and the start signal START, and outputs the parallel signals to each current source CS. In this embodiment, the multiplexer MLT outputs the video signal as a 6-bit digital signal to each current source CS.

The reference transistor TR_{ref} is a p-channel thin-film transistor in this embodiment. A source of the reference transistor TR_{ref} is connected to a constant-potential terminal ND1′ via a resistance element R. A drain of the reference transistor TR_{ref} is connected to a ground wire. When driving the display, a reference current I_{ref} is made to flow between the source and drain of the reference transistor TR_{ref}.

The current source CS is connected between an output terminal of the video signal line driver XDR, i.e., the terminal connected to the video signal line, and the ground wire. The current source CS converts the digital signal which the multiplexer MLT output as parallel signals into an analog signal. In this embodiment, the current source CS converts the 6-bit digital video signal which the multiplexer MLT outputs into the analog video signal as a current signal.

The current source CS includes a plural sets of a constant-current source TR_{dgt} and a switch SW_{dgt}. The constant-current source TR_{dgt} and the switch SW_{dgt} of each set are connected in series between the output terminal of the video signal line driver XDR and the ground wire. In this embodiment, the current source CS includes six sets of the constant-current source TR_{dgt} and the switch SW_{dgt}, and the constant-current sources TR_{dgt} and the switches SW_{dgt} are p-channel field-effect transistors.

Gates of the constant-current sources TR_{dgt} are connected to a gate of the reference transistor TR_{ref}. Gate of the switches SW_{dgt} are connected to the output terminals of the multiplexer MLT, respectively.

For example, one of the constant-current sources TR_{dgt} has the same structure as that of the reference transistor TR_{ref}, and the remaining five have the same structure as that of the reference transistor TR_{ref} except for channel width. The six constant-current sources TR_{dgt} output constant-currents having magnitudes one time, two times, four times, eight times, sixteen times, and thirty two times the magnitude of the reference current I_{ref}, respectively, while the switches SW_{dgt} are closed.

The switch SWᵥₛ and the voltage source VS are connected in series between the output terminal of the video signal line driver XDR and the ground wire in this order.

The voltage source VS outputs a reset signal as a constant-voltage. For example, an output of the voltage signal VS is a constant-voltage almost equal to the voltage of the video signal line DL to be set by a write operation when the video signal corresponds to the lowest gray level.

In this embodiment, the switch SWᵥₛ is a p-channel field-effect transistor. A gate of the switch SWᵥₛ is connected to the control line CL. The control line CL is supplied with a control signal BLK whose signal level changes almost in synchronization with changeovers between a blanking period and an effective scanning period.

The protection circuit PC2 is connected to the output terminal of the video signal line driver XDR. The protection circuit PC2 includes diodes D2a and D2b. The diode D2a is connected between the output terminal of the video signal line driver XDR and a high-potential terminal NDH′ such that a forward current flows through the diode D2a from the output terminal of the video signal line driver XDR to the high-potential terminal NDH′. A potential of the high-potential terminal NDH′ is to be set higher than that of the output terminal of the video signal line driver XDR. The diode D2b is connected between the output terminal of the video signal line driver XDR and a low-potential terminal NDL′ such that a forward current flows through the diode D2a from the low-potential terminal NDL′ to the output terminal of the video signal line driver XDR. A potential of the low-potential terminal NDL′ is to be set lower than that of the output terminal of the video signal line driver XDR. In this embodiment, The diode D2a is a p-channel field-effect transistor whose gate is connected to the high-potential terminal NDH′, and the diode D2b is an n-channel field-effect transistor whose gate is connected to the ground wire.

The scan signal line driver YDR is further mounted on the display panel DP. As described above, the scan signal lines SL1 and SL2 are connected to the scan signal line driver YDR.

The organic EL display is driven by, for the example, the method described below.

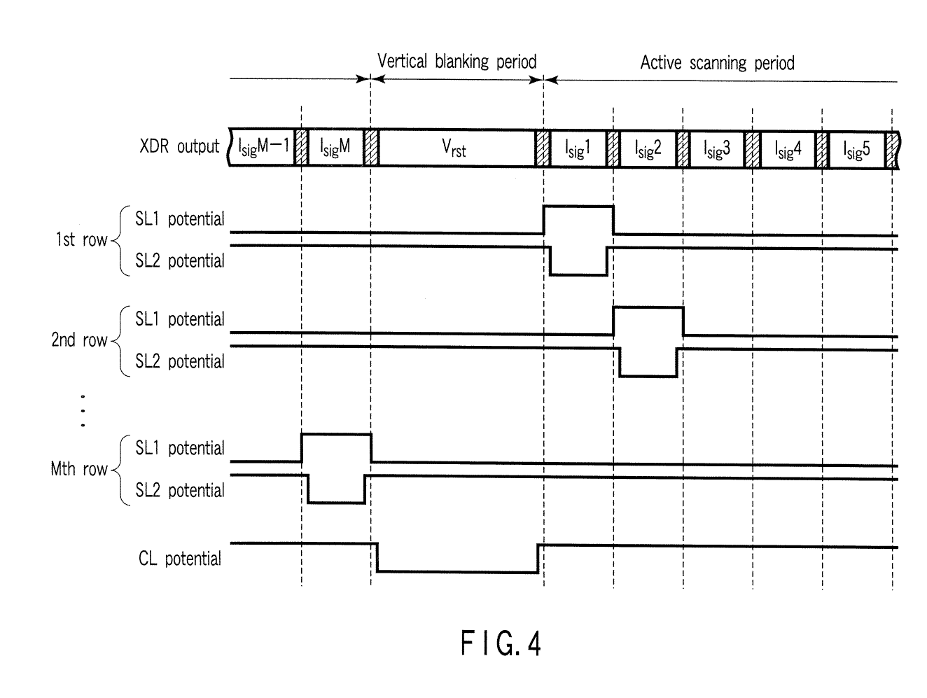

FIG. 4 is a timing chart schematically showing an example of a method of driving the display shown in FIGS. 1 to 3. FIG. 4 illustrates a driving method in the case that the number of rows which the pixels form is M. In the figure, the abscissa indicates time, while the ordinate indicates potential.

As for the “XDR output” in FIG. 4, during the period shown as “I_{sig}(m)”, the video signal line driver XDR outputs a video signal I_{sig}(m) to the video signal line DL. During the period shown as “Vᵣₛₜ”, the video signal line driver XDR outputs a reset signal Vᵣₛₜ to the video signal line DL. In FIG. 4, the waveforms shown as “SL1 potential” and “SL2 potential” represent the potentials of the scan signal lines SL1 and SL2, respectively. In FIG. 4, the waveform shown as “CL potential” represents the potential of the control signal line CL.

According to this method, an effective scanning period and a blanking period are repeated alternately. During the effective scanning period, rows of the pixels are sequentially selected while the switch SWᵥₛ is opened. A write operation is executed on each pixel included in a selected row. A display operation is executed on each pixel included in non-selected rows.

For example, during a period that a m-th row of pixels is selected (to be referred to as m-th row selection period), the switch SWa of each pixel included in the m-th row is opened. Then, the multiplexer MLT outputs 6-bit digital video signal to each current source CS, and the switches SWb and SWc of each pixel included in the m-th row are closed.

The current source CS converts the digital video signal into a write current I_{sig}m as an analog video signal. The write current I_{sig}m flows from the first power supply terminal ND1 to the current source CS. As a result, the gate potential of the drive control element DR is set at a value when the write current I_{sig}m flows between the source and drain of the drive control element DR.

Thereafter the switches SWb and SWc are opened. Then, the switch SWa is closed to finish the m-th row selection period.

When the switch SWa is closed, a drive current I_{drv}m whose magnitude corresponds to a magnitude of the write current I_{sig}m flows through the organic EL element OLED. During the non-selection period, the switch SWa is kept closed. Therefore, the organic EL element OLED of each pixel PX continues light-emission at a luminance corresponding to the magnitude of the drive current I_{drv}m until the pixel is selected again.

During a blanking period, a reset operation is executed. Firstly, all the switches SW_{dgt} are opened. Then, the switch SWᵥₛ is closed, and the voltage source VS outputs a reset signal to the video signal line DL. That is, the potential of the video signal line DL is set at a reset potential. Subsequently, the switch SWᵥₛ is opened. Note that, during the blanking period, the switches SWb and SWc are kept open in all the pixels PX.

Given that the video signal line driver XDR of the display does not include the voltage source VS and the switch SWᵥₛ, the video signal line DL can be considered to be in floating state during the blanking period. However, a small reverse current, i.e., a leakage current, flows through each of the diodes D1a, D1b, D2a, and D2b. The sum of the leakage currents flowing through the diodes D1a and D2a is not necessarily equal to the sum of the leakage current flowing through the diodes D1b and D2b.

For this reason, the potential of the video signal line DL just after the blanking period ends may differ from the potential of the video signal line DL just after stating the blanking period. For example, the potential of the video signal line DL just after the blanking period ends may be lower than the lowest potential of the video signal line DL to be set by the write operation.

In this case, in order to display a gray level within a low gray level range on a pixel PX in the 1st row, the potential of the video signal line DL must be greatly increased by the write operation during the 1st row selection period. However, since a magnitude of the write current I_{sig}1 for displaying a gray level within the low gray level range is small, it is difficult to sufficiently change the potential of the video signal line DL during the 1st row selection period. Thus, for the pixel in the 1st row, the gate potential of the drive control element DR cannot be accurately set at a value corresponding to a magnitude of the write current I_{sig}1, and this makes it difficult to display each gray level within the low gray level range with a high reproducibility.

When the potential of the video signal line DL greatly changes during the blanking period, a similar phenomenon occurs in the pixels PX included in several rows encountered after the active scanning period has started. It is thus conventionally difficult for the pixels PX in several rows first selected during the active scanning period to display gray levels in the low gray level range with a high reproducibility.

In contrast, by executing the reset operation described with reference to FIGS. 1 to 4 during the blanking period, the potential of the video signal line DL just before starting the write operation on the pixels PX in the 1st row can be set almost equal to the reset potential. Consequently, by setting the reset signal at a value almost equal to the potential of the video signal line DL to be set by the write operation when the video signal I_{sig}m corresponds to the lowest gray level for example, it becomes possible to greatly decrease an amount of change in the potential of the video signal line necessary for displaying a gray level within the low gray level range on the pixels PX in the 1st row. Therefore, it is possible for the pixels PX in several rows first selected during the active scanning period to display gray levels in the low gray level range with a high reproducibility.

The magnitude of the reset signal may be differ from the potential of the video signal line DL to be set by the write operation when the video signal I_{sig}m corresponds to the lowest gray level. The magnitude of the reset signal may be set at a voltage within a voltage range of the video signal line that the write operation can set. In view of displaying each gray level in the low gray level range with a high reproducibility, it is advantageous that the magnitude of the reset signal is almost equal to the voltage of the video signal line DL to be set by the write operation when the video signal corresponds to the lowest gray level.

A second embodiment of the present invention will be described below.

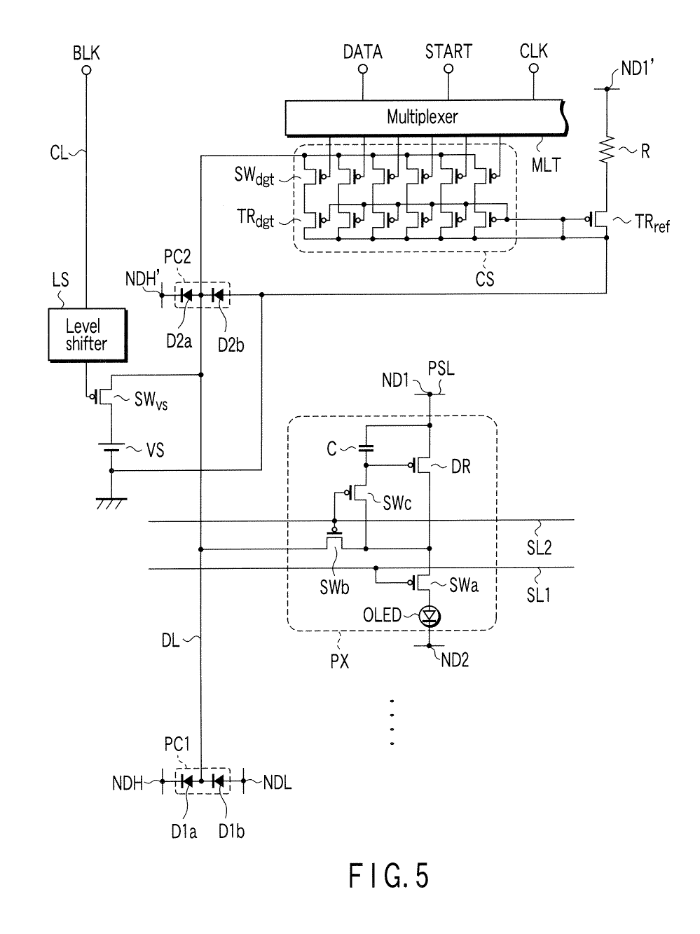

FIG. 5 is an equivalent circuit diagram showing a part of a display according to the second embodiment of the present invention. The display is a bottom emission organic EL display employing an active matrix driving method. The organic EL display has a structure similar to that of the organic EL display shown in FIGS. 1 to 3 except that the following configuration is employed.

In this display , the switch SWᵥₛ and the control line CL are built into the display panel DP instead of the video signal line driver XDR. Further, in this display, the display panel DP further includes a level shifter LS. The switch SWᵥₛ and the constant-voltage source VS are connected in series between the video signal line DL and the ground wire in this order. An input terminal of the level shifter LS is connected to the control line CL. An output terminal of the level shifter LS is connected to the gate of the switch SWᵥₛ.

This display can be driven in a manner almost similar to that described with reference to FIG. 4. Consequently, the present embodiment exerts effects similar to those described in the first embodiment.

In the first and second embodiments, the structures shown in FIGS. 1, 3, and 5 are adopted for the pixels PX. However, other structures can be used for the pixels PX. For example, the diode-connecting switch SW_{c} may be connected between the gate of the drive control element DR and the video signal line DL rather than being connected between the drain and gate of the drive control element DR. Alternatively, the selector switch SW_{b} may be connected between the gate of the drive control element DR and the video signal line DL rather than being connected between the drain of the drive control element DR and the video signal line DL.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A display comprising:
a video signal line;
a current source which outputs a video signal;
a voltage source which outputs a reset signal; and
pixels which are arranged along the video signal line, each of the pixels including a drive circuit which outputs a drive current at a magnitude corresponding to a magnitude of a video signal, and a display element which changes its optical characteristics in accordance with a magnitude of a current flow through the display element,
wherein the display is configured to alternately repeat an active scanning period and a blanking period, sequentially select the pixels during the active scanning period, execute a write operation on the selected pixel, execute a display operation on each of the non-selected pixels, and execute a reset operation during the blanking period,
wherein the write operation includes connecting the drive circuit to the current source via the video signal line to write the video signal on the drive circuit while disconnecting the display element from the drive circuit,
wherein the display operation includes connecting the drive circuit to the display element to make the drive current flow through the display element while disconnecting the drive circuit from the video signal line, and
wherein the reset operation includes connecting the voltage source to the video signal line to write the reset signal on the video signal line while disconnecting the current source from the video signal line.

2. The display according to claim 1, wherein a magnitude of the reset signal is set at a voltage within a voltage range of the video signal line that the write operation can set.

3. The display according to claim 1, wherein a magnitude of the reset signal is set at a voltage of the video signal line to be set by the write operation when the video signal corresponds to the lowest gray level.

4. The display according to claim 1, further comprising a protection circuit including a first diode which is connected between the video signal line and a high-potential terminal such that a forward current flows through the first diode from the video signal line to the high-potential terminal, and a second diode which is connected between the video signal line and a low-potential terminal such that a forward current flows through the second diode from the low-potential terminal to the video signal line.

5. The display according to claim 1, wherein the drive circuit includes:
a drive control element which comprises a control terminal, a first terminal connected to a power supply terminal, and a second terminal outputting a current at a magnitude corresponding to a voltage between the control terminal and the first terminal;
a capacitor which is connected between a constant-potential terminal and the control terminal; and
a switch group which switches between first and second states, the first state being a state that the second terminal, the control terminal, and the video signal line are connected to one another, and the second state being a state that the second terminal, the control terminal, and the video signal line are disconnected from one another.

6. The display according to claim 1, wherein the display element is an organic EL element.
